(19) United States
(12) Patent Application Publication
(10) Pub. No.: US 2019/0164407 A1
(43) Pub. Date: May 30, 2019

(54) System and Method for Accident Monitoring in a Facility

(71) Applicant: Walmart Apollo, LLC, Bentonville, AR (US)

(72) Inventor: Andrew B. Millhouse, Gilbert, AZ (US)

(21) Appl. No.: 16/204,142

(22) Filed: Nov. 29, 2018

Related U.S. Application Data
(60) Provisional application No. 62/592,663, filed on Nov. 30, 2017.

(51) Int. Cl. G08B 21/18; H04W 4/38; H04W 4/33; H04W 4/90

(52) U.S. Cl. CPC G08B 21/182; G08B 21/187; H04W 4/90; H04W 4/33; H04W 4/38

(57) ABSTRACT

A system and a method for accident monitoring and response are disclosed. The system retrieves a current task item for a user associated with the user's device. The system monitors condition information associated with the current task. The system populates a graphical user interface on a user's device with a list of possible incidents based on the current task and in response the condition information. The system transmits the selection of one of the possible incidents to the server. A responder device retrieves a list of remedies from the server in response the selected incident, and populates a graphical user interface on the responder device with the list of remedies. Upon selection, the responder device transmits the selection of the remedies to the server for response team dispatch.

### RELATED APPLICATIONS

This application claims priority to U.S. Provisional Application No. 62/592,663 filed on Nov. 30, 2017, the content of which is hereby incorporated by reference in its entirety.

### BACKGROUND

Detection and response to the accidents in facilities can be slow, inefficient, and dangerous.

### BRIEF DESCRIPTION OF DRAWINGS

Illustrative embodiments are shown by way of example in the accompanying drawings and should not be considered as a limitation of the present disclosure:

FIG. 1 is a block diagram illustrating a system for accident monitoring in a facility according to an exemplary embodiment.

FIG. 2A illustrates a graphical user interface for the reporting of accidents in a facility according an exemplary embodiment.

FIG. 2B illustrates a graphical user interface for the responding to reports of accidents in a facility according to an exemplary embodiment.

FIG. 3 is a flowchart illustrating a process for reporting and responding to accidents according to an exemplary embodiment.

FIG. 4 is a block diagram illustrating an electronic device for supporting accident monitoring in a facility according to an exemplary embodiment.

FIG. 5 is a block diagram of an exemplary mobile device that can be utilized to detect accidents in a facility according to an exemplary embodiment.

### DETAILED DESCRIPTION

Described in detail herein is a system for efficient targeted accident detection/monitoring, and reporting for prompt and responsive remediation. The system detects and identifies potential accidents based on a current location and task of a user and provides the user with a user interface for reporting accidents.

In one embodiment, the invention collects sensor information from the user's handheld device or communicatively coupled utility equipment consistently through a workday. The handheld receives information indicating a task that the user is to perform within a facility. The handled device determines based on the sensor information whether an accident has occurred. An accident may be determined based on internal sensors readings from the handheld device, e.g., accelerometer readings, gyroscope readings, acoustic transducer (microphone) readings, and the like. Alternatively, the utility equipment can include sensors and provide sensor readings, e.g., accelerometer readings, gyroscope readings, acoustic transducer (microphone) readings, scale/force/pressure readings to provide weight measurements of any freight being supported by the utility equipment. Rapid changes in one or more sensor readings, e.g., in accelerometer data and/or changes in weight distribution on the communicatively coupled utility equipment can be indicative an incident/accident. For example, if a pallet jack is outfitted with weight sensors on supportive surfaces; under load, any change on the weight sensors can indicate a load shift. An accident can be detected, for example when the detected shift in the load is coupled with a rapid change in accelerometer data corresponding to the pallet jack impacting an object. The handheld device can determine location by GPS location, triangulation, as well as manual input (e.g. Aisle 103) via keypad or voice recognition, to identify the location of the accident. The handheld device can present the user with a determined set of possible incidents based on the current task in work. For example, the handheld device can include “collision” as a possible incident based on the task in work, as the task in work requires a forklift. The user selects an incident from the curated possible incident list which is then transmitted to a remediating device. Based on the selected incident, the selected incident can be sent to different remediating devices. For example, different managers can be responsible for different areas within a facility. When the incident is selected, the location information can be taken into account and determinative as to which remediating device receives the incident report. The remediation device receives a list of remedies to be utilized to address the incident. The remediation device receives an input for the appropriate response for the incident, and notifies the appropriate responder to address the incident. The responder(s) may be employees or contractors associated with the facility and/or may be third parties. For example, if the selected incident is a fire, the remediation device can populate a list containing a single item including “Notify Fire Department and Internal Response Team.” Upon selection, of the “Notify Fire Department and Internal Response Team” option, responder devices associated with the fire department and internal response team can receive notifications of the incident. Other incidents such as chemical spills, and injuries can notify responder devices associate with internal response teams and/or third parties including hazmat teams, and ambulances.

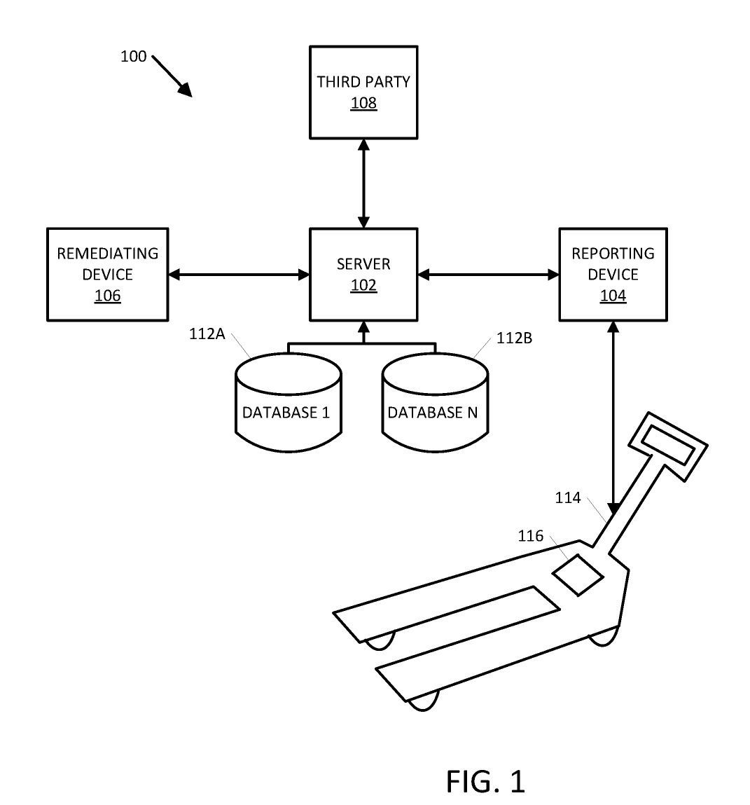

FIG. 1 is a block diagram illustrating a system 100 for accident detection/monitoring in a facility according to an exemplary embodiment. Embodiments of the system 100 can include one or more servers 102, reporting devices 104, remediating devices 106, responder devices 108, databases 112A, 112B, and utility equipment 114.

In one embodiment, the server 102 can be an infrastructure computing system that resides in a shared computing environment or data center, a stand-alone computer, and/or a virtual instance executing in a virtual machine implemented by one or more computing devices. The server 102 can be configured to provide interfaces to the reporting device 104, the remediating device 106, the databases 112A, 112B, and the responder device 108. The server 102 can be communicatively connected to external systems and subsystems in the system. The connections can be wireless or wired. Wireless communication can be implemented in standards-based interfaces including WiFi and 4G Long Term Evolution (LTE). Other wireless communication standards can be used in implementation as long as the standards support the higher application layers of the Open Systems Interconnect (OSI) stack necessary to support the system 100. Similarly, the server 102 may be connected through wired connections. The wired connections may include any physical medium and underlying OSI stack as to support the higher level application layers to support the system 100.

The reporting device can be communicatively coupled to the server 102. In one embodiment, the reporting device 104 can be a handheld or mobile device, such as a smart phone, smart watch, or tablet-style computing device. Alternatively, the reporting device 104 can be integrated into the utility equipment 114 utilized by user in the course of their tasks or activities. Integrated embodiments can include pallet jacks and fork lifts. In some embodiments, the reporting device 104 can be carried by the user and can be in communication with electronics disposed on or integrated with the utility equipment 114. The reporting device 104 provides the computing platform for receiving input from an array of sensors. The sensors can include but are not limited to accelerometers, gyroscopes, altimeters, weight scales, and thermometers. The array of sensors can be physically integrated into the reporting device 104. Alternatively, the array of sensors can be logically integrated via wirelessly coupling the array of sensors to the reporting device 104. As one example, the array of sensors can be disposed in the environment surrounding the reporting device 104 and can be disposed on the utility equipment 114. Communication support to facilitate communication between the reporting device 104 and the sensors in the environment and/or on the utility equipment 114 can include Bluetooth®, Zigbee, a near-field communications (NFC) transmitters or other comparable wireless stacks. Additionally, the array of sensors can be implemented within an Internet of Things framework such as ioTivity or Zephyr, which support a development stack with underlying communication application programming interfaces (APIs) already implemented. Additionally, the array of sensors can be selectively powered off based on the current assigned task to save energy of the sensory array, processing power for the reporting device, and bandwidth on the network.

The reporting device 104 can host and/or render a graphical user interface (GUI) for the display, selection and transmittal of accident pertinent information. For example, the GUI can be displayed on a touchscreen of the reporting device 104 and provide responsive feedback after interaction with the user. Alternatively, the GUI can provide voice prompts and can respond to voice commands.

Like the reporting device 104, the remediating device 106 can be a mobile device, such as a smart phone, smart watch, or tablet-style computing device, or can be a personal computing device or server. The remediating device 106 can execute an application to facilitate communicate with the server 102, to provide instructions to the responder device 108. The instructions can be actions to be taken in response to the accident reported by the reporting device 104. The instructions can contain relevant information for the responder device 108 to respond, including location information, condition information, and the desired remedy for the referenced accident. The instruction can be informational to inform the responder device 108 of the accident reported by the reporting device 104.

The remediating device 106 can host and/or render a graphical user interface (GUI) for the display, response and transmittal of pertinent accident response information. The GUI can be displayed on touchscreen of the remediating device 106 and can provide responsive feedback after interaction with the user. Alternatively, the GUI can provide voice prompts and can respond to voice commands.

The responder device 108 receives information from the remediating device 106. The responder device 108 can be associated with responsible parties for addressing accidents as reported by the reporting device 104. The server 102 can relay or notify the responder device 108 by the transmission of a digital message to the responder device 108. The message can include a text message containing the location information, condition information, and the type of accident. The message can take the form of a digitally formatted message to be interpreted by a client executing on a device in the responder device 108. Upon receiving and interpreting the message, the client then presents the message to a user of the responder device 108 through a GUI. Alternatively, the server 102 can notify the responder device 108 through a telephone call, utilizing text-to-speech to convert the digital message in a human understandable way across the telephone circuit. The server 102 can utilize the text-to-speech conversion to relay the message over a public announcement system within the facility where the accident occurred.

The databases 112A, 112B can be internal or external to the server. The databases 112A, 112B can be virtually implemented across a number of computing devices, where the interfaces to access the databases abstracted and are consistent with other database implementations. The databases 112A, 112B contain information relevant to the current task items of the user using the reporting device 104. The databases 112A, 112B also can contain records of known accidents to occur in the course of completing known current task items. The databases 112A, 112B can contain flexible record entries as well as the means to create flexible record entries for unknown accidents. The databases 112A, 112B can also contain relational indexes to other tables corresponding to associated attributes to each current task itemed. For example, for a given current task item for warehouse picking, a relational database key for the goods to be picked, can be included in the current task item record. The relational information can be used to further direct the remediating device 106 when notifying the responder device 108.

As described herein, the utility equipment 114 can be communicatively coupled with the reporting device 104. As mentioned above, the utility equipment 114 can support wireless communication for an array of onboard sensors. The utility equipment 114 can take the form of any piece of equipment utilized to complete or aid in completion of a current task item. In a warehouse environment, the utility equipment 114 can take the form of a pallet jack (as shown), a fork lift, or any other suitable equipment. The utility equipment 114 can host one or more sensor modules 116. The one or more sensor modules 116 can host an array of sensors attached to the utility equipment 114 or disposed internally to the sensor module. The sensor modules 116 can provide a coordinated communication point for all the sensors on the utility equipment 114 and can interact with the reporting device 104. The sensor module 116 can package data from the sensor array located on the utility equipment 114 and transmit the packaged data to the reporting device 104.

In exemplary embodiments, the reporting device 104 can selectively enable or disable communication with the sensor module 116 based on the task for which the utility equipment 114 is being employed. As one example, a task assigned to a user carrying the reporting device 104 can instruct the user to move a pallet of freight from a specified location to another specified location with a forklift (e.g., utility equipment 114). When the location of the reporting device 104 is determined to be at the specified location, the reporting device 104 can establish a communication channel with the sensor modules on the fork lift to initiate accident detection and monitoring based on sensor data output from the sensor modules 116 of the forklift. The communication channel can remain open as the user performs the task. When the user drives the pallet of freight to the other location, place the freight at the other location (which can be detected by detecting a position of the forks and a weight/force on the forks as detected by the sensor module(s)), the reporting device can terminate the communication channel.

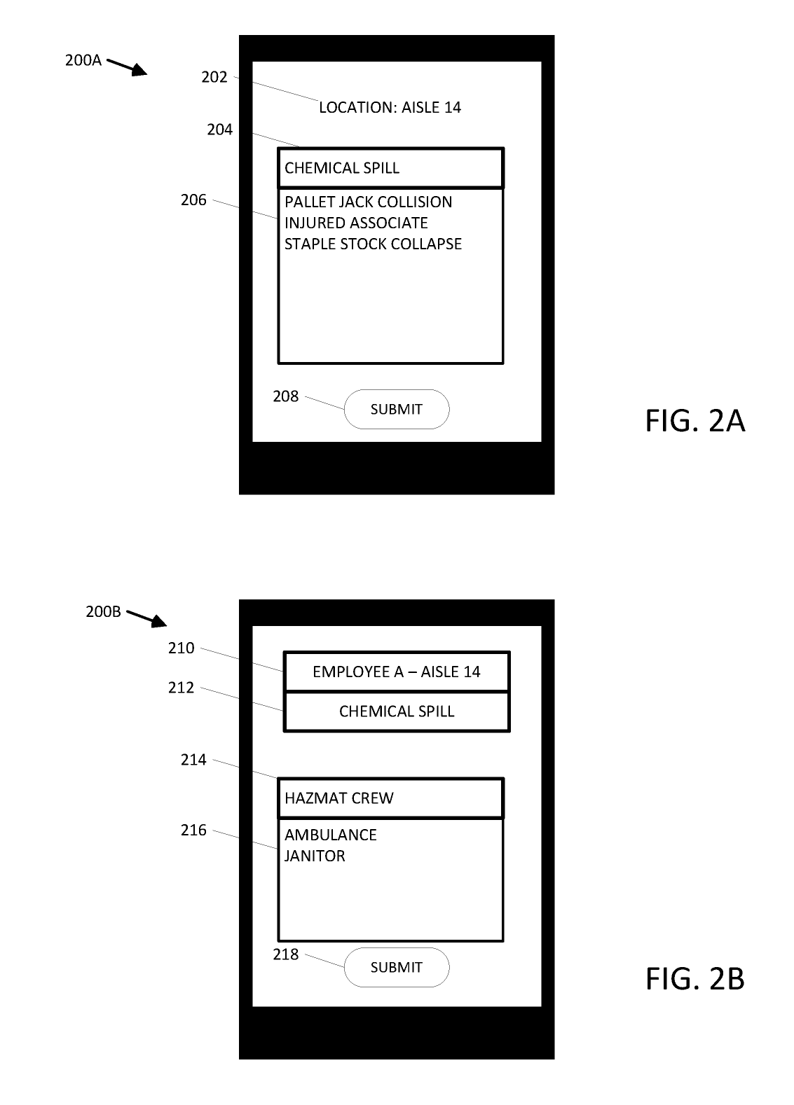

FIG. 2A illustrates a graphical user interface (GUI) 200A for the reporting of accidents in a facility according an exemplary embodiment. The GUI illustrated in diagram 200A is consistent with that to be displayed on the reporting device 104 upon an accident during a current task item.

Present in the GUI can be an indication of location information 202. The location information 202 can be displayed in a textual sense corresponding to a description of the location of the accident. In a warehouse embodiment, the location information 202 can correspond to an aisle or dock. Alternatively, the location information 202 can be visually displayed. A map can be instantiated in the GUI with a drop pin indicating the location of the accident.

Location information 202 can be extracted through the array of sensors inclusive to the reporting device 104, or an array of sensors present on utility equipment 114 communicatively coupled to the reporting device 104. Data received from global positioning system receivers in the array of sensors and/or reporting device 104 can be utilized to provide location information 202. Alternatively radio triangulation can be utilized to identify location information corresponding to the position of the reporting device 104 at the time of the reported accident. The location information 202, the current task item, a user identifier, as well as any status information provided by the array of sensors can become a part of a generalized condition information.

The GUI displays a selected accident 204. The selected accident 204 can be chosen by the user of the reporting device 104 through a drop down menu widget. Alternatively, the selected accident 204 can be selected from a spinner widget or listview widget. The selected accident 204 can be entered manually through a text entry box in the GUI, if the desired entry for the selected accident 204 is not present in the list. Additionally text entry can index into the dropdown menu, spinner or listview for more efficient selection of the selected accident 204.

The GUI displays a list of suggested accidents 206. The list of suggested accidents 206 are presented through a dropdown menu widget. As mentioned above the list of suggested accidents 206 can be presented as a listview or a spinner widget. The list of suggested accidents 206 is determined from the databases 112A, 112B based on the current task item, the location information, and/or the sensor data. The list of suggested accidents 206 are accidents known to have historically taken place during previous executions of the current task item, or are reasonable foreseeable given the nature of the current task item. For example, if the current task item is to pick hazardous chemicals, the list of suggested accidents 206 can include accidents related to hazardous chemicals, including chemical spill, or injured associate. Additionally, the list of suggested accidents 206 can include accidents that historically have occurred or can be reasonably foreseen based on the utility equipment 114 utilized for the current task item. For example, pallet jack collision or staple stock collapse could be included in the list of suggested accidents 206.

The GUI can also include an accident submission button 208. The accident submission button 208 can be inactive until the user of the reporting device 104 identifies a selected accident 204 from list of suggested accidents 206 or enters through text entry a selected accident 204 not present in the list of suggested accidents 206. The accident submission button 208 invokes a function to encode a message including a user identifier corresponding to the user utilizing the reporting device 104, the location information 202, and the selected accident 204. Upon encoding, the function transmits the message to the server 102, which may be processed and retransmitted to the remediating device 106, or the server can relay the message unmodified to the remediating device 106.

Alternatively from the aforementioned text entry based GUI, the GUI can be voice responsive. The reporting device 104 can receive voice based commands to identify a selected accident 204. The GUI identifies the voice based command and renders the voice command to a textual input corresponding to the selected accident 204 or a submission command activating the accident submission button 208 without manual interaction.

FIG. 2B illustrates a GUI 200B for responding to reports of accidents in a facility according to an exemplary embodiment. The GUI 200B represents receiving, at the remediating device 106, a communication instantiated by the invoking of the accident submission button 208 on the reporting device 104.

Upon the receipt of the message transmitted upon the invoking of the accident submission button 208, relevant accident information is extracted out of the message and displayed in the GUI 200B. Location information 210 for the accident can be extracted from the message. The accident location information 210 provides the user of the remediating device 106 with an indication of the user reporting the accident and the location of the accident. The accident location information 210 corresponds, at least in part, to the location information 202 as determined by the reporting device 104. Also extracted from the message is the reported accident 212. The reported accident 212 corresponds to the selected accident 204 from the reporting device.

Similar to the selected accident 204 and the list of suggested accidents 206, the remediating device 106 presents a selected remedy 214 and a list of suggested remedies 216. Like the selected accident 204, the selected remedy 214 can be implemented as a dropdown menu, a listview or a spinner widget. For more efficient navigation, the selected remedy 214 can be input in a text box, which can either identify and select a choice in the list of suggested accidents 206, or provide an alternative entry that is not suggested.

Similar to the accident submission button 208, the GUI 200B rendered by the remediating device 106 can include a response submission button 218. Invoking the response submission button 218 calls a software function that encodes the accident location information 210, as well as the selected remedy 214. Once encoded in a message, the message is transmitted to the server 102. The server 102 receives the message, decodes it, and based on the selected remedy 214, notifies a responder device 108.

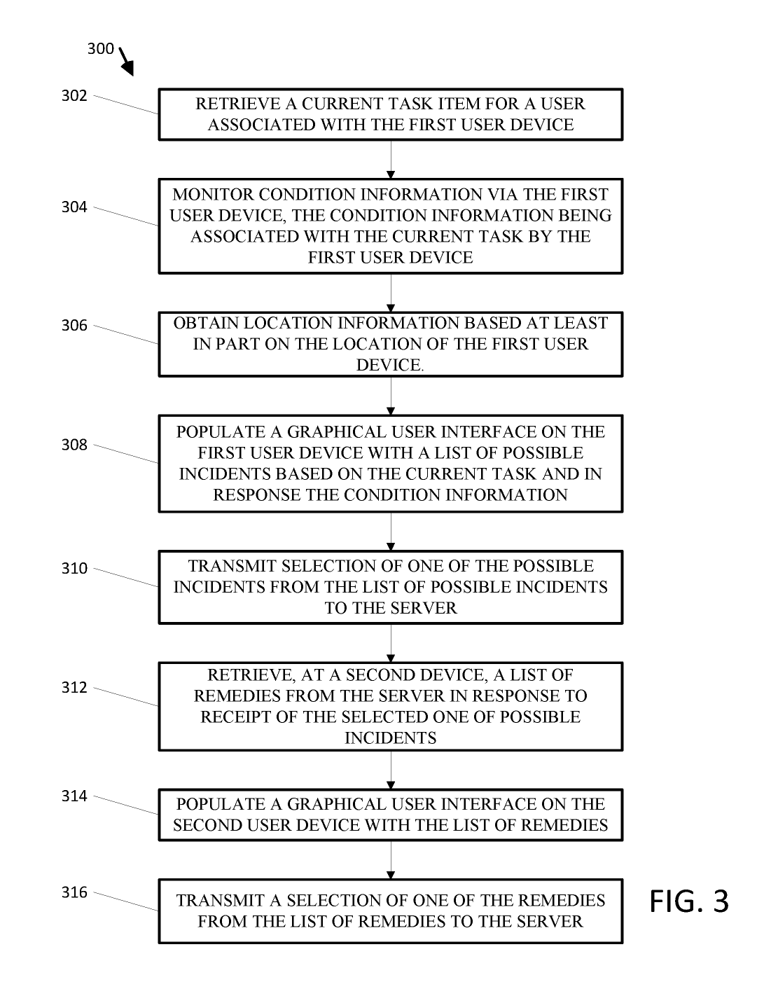

FIG. 3 is a flowchart illustrating a process 300 for reporting and responding to accidents according to an exemplary embodiment.

At step 302, a current task item for a user associated with the reporting device is retrieved by the server. The server 102 interfaces the databases 112A, 112B and identifies a current task item based on a user record and a timedate stamp. The user record can be a foreign key in the current task item record to another table that identifies the user of the reporting device 104.

At step 304, condition information is monitored via the reporting device, and the reporting device associates the condition information with the current task. Condition information provides an encompassing view of the state of activity with the current task. The condition information provides encapsulation for the data being collected during the performance of the current task. The condition information aggregates status information and location information and correlates it to the current task. The reporting device can generate status information correlating to the condition information. Status information, as provided by the reporting device 104, can include data from the array of sensors that can signal unexpected changes in output indicative of an accident. Status information takes the form of the raw data collected by the array of sensors. The unexpected changes in output can be indicative of, for example, an abrupt load shift or collision. Status information, as well as location information can be included within the condition information to provide a complete view of the condition of the current task.

At step 306, location information is obtained based at least in part on the location of the first user device. Additionally, location information can be retrieved from the sensor module 116 of the utility equipment 114 for improved accuracy. Location information can be retrieved by global positioning satellite systems, or signal triangulation system. Manual input can also be utilized to obtain location information by way of user input into a virtual or physical keyboard or voice recognition systems.

At step 308, a graphical user interface on the reporting device is populated with a list of possible incidents based on the current task item and in response to the condition information. The reporting device can query the databases 112A, 112B through the server 102 for records corresponding to the current task item at the time of the possible incident. In conjunction with the condition information, the reporting device 104 eliminates any accident choices from the list of suggested accidents 206. For example, the reporting device can use outputs from the sensors that indicative of unexpected changes and/or the location information to eliminate accident choices from the list. In another embodiment, the reporting device 104 can conversely include only accident choices corresponding to the current task item and the unexpected changes in output.

In yet another embodiment, the reporting device 104 can encode the condition information and transmit it to the server 102. The server 102 can decode the condition information and perform the database queries and transmit the list of suggested accidents 206 to the reporting device to save processing power on any power limited reporting device. Based on the condition information, the list of suggested accidents 206 can be narrowed for reduced computational complexity in rendering the GUI, and reduced bandwidth to transmit selections. For example, condition information containing status information from accelerometers indicating an abrupt change in direction, can limit the list of selectable items to those indicative of a collision. In another embodiment, scales attached to utility equipment 114 can indicate changes indicating load shift. A combination of the accelerometer data indicating collision and scale data indicating load shift, can indicate a severe collision.

At step 310, selection of one of the possible incidents from the list of possible incidents can be received by the reporting device via the GUI in response to input from the user. The selected accident, along with some or all of the condition information are encoded and transmitted to the server 102. As described above in relation to FIG. 2A, transmission of the accident occurs after the accident submission button 208 is invoked.

At step 312, the remediating device retrieves a list of remedies from the server in response to receipt of the selected one of possible incidents. Upon receipt of the selection at the server 102, the server can notify the remediating device that an accident has occurred. In this implementation, the remediating device would request the list of remedies based on the notification. Alternatively, upon the receipt of the selection at the server 102, the server can push the notification and the list of remedies in one transaction. The server 102 limits the list of remedies based on the condition information, which can include the selected accident 204, the condition information, and/or the location information. The databases 112A, 112B contain relevant remedies in relational tables where a task item can have one or more remedies. The one or more remedies may correspond to a level of severity for the accident. The server 102 encodes a message including the list of suggested remedies 216 as well as condition information including the accident, location information, and a user identifier corresponding to the reporting device. The server 102 transmits the resultant message to the remediating device 106.

At step 314, a graphical user interface rendered on the remediating device is populated with the list of remedies generated by the server. Upon receiving the message, the remediating device 106 decodes the message and extracts the list of suggested remedies 216 as well as the condition information. The GUI instantiates or updates the user interface widgets with their respective fields as described in relation to FIG. 2B.

At step 316, selection of one of the remedies from the list of remedies can be received by the remediating device via the GUI in response to input from the user of the remediating device. Upon the selection of a remedy at the remediating device 106, the condition information and the location information can be encoded into a message, which is transmitted to the server 102. The server 102 reformats the contents of the message into a format necessary to interact with a responder device 108. The responder device 108 can receive the messages and present them to a user of the responder device. In one embodiment, the responder device can take the form of a smartphone handset or a tablet. Formats may include short message service (SMS) text messages, emails, specialized messaging formats for responder specific computer application, as well as text to speech implementations for automated dialing and notification systems (“robocallers”) and public announcement systems. In another embodiment, the server 102 can select an appropriate responder device 108 based the selection of the possible incidents, the condition information, the location information, and the current task item. For example, if the selected possible incident corresponds to a fire, the server 102 can automatically notify responder devices associated with emergency responders equipped to handle a fire.

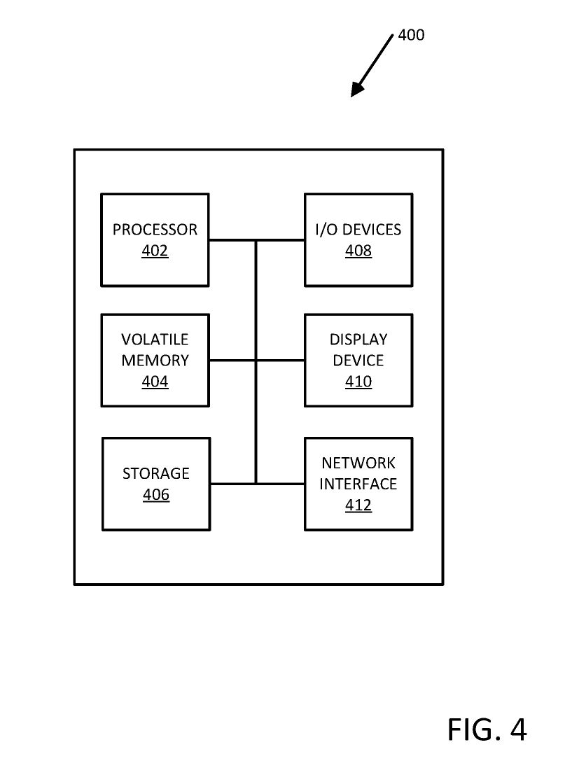

FIG. 4 is a block diagram illustrating a computing device 400 for supporting accident monitoring in a facility according to an exemplary embodiment.

The computing device 400 supports accident monitoring in a facility. The computing device 400 can embody the server 102, the reporting device 104 and the remediating device 106. The computing device 400 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more flash drives, one or more solid state disks), and the like. For example, volatile memory 404 included in the computing device 400 can store computer-readable and computer-executable instructions or software for implementing exemplary operations of the computing device 400. The computing device 400 also includes configurable and/or programmable processor 402 for executing computer-readable and computer-executable instructions or software stored in the volatile memory 404 and other programs for implementing exemplary embodiments of the present disclosure. Processor 402 can be a single core processor or a multiple core processor. Processor 402 can be configured to execute one or more of the instructions described in connection with computing device 400.

Volatile memory 404 can include a computer system memory or random access memory, such as DRAM, SRAM, EDO RAM, and the like. Volatile memory 404 can include other types of memory as well, or combinations thereof.

A user can interact with the computing device 400 through a display 410, such as a computer monitor, LED or OLED display, which can display one or more graphical user interfaces supplemented by I/O devices 408, which can include a multi-touch interface, a pointing device, an image capturing device and a reader.

The computing device 400 can also include storage 406, such as a hard-drive, CD-ROM, or other computer-readable media, for storing data and computer-readable instructions and/or software that implement exemplary embodiments of the present disclosure (e.g., applications). For example, storage 406 can include one or more storage mechanisms for storing information associated with task items and possible incidents based on the task items can be indexed accordingly. The storage mechanism can be updated manually or automatically at any suitable time to add, delete, and/or update one or more data items in the databases 112A, 112B.

The computing device 400 can include a network interface 412 configured to interface via one or more network devices with one or more networks, for example, Local Area Network (LAN), Wide Area Network (WAN) or the Internet through a variety of connections including, but not limited to, standard telephone lines, LAN or WAN links (for example, 802.11,T1, T3, 56 kb, X.25), broadband connections (for example, ISDN, Frame Relay, ATM), wireless connections, controller area network (CAN), or some combination of any or all of the above. In exemplary embodiments, the network interface 412 can include one or more antennas to facilitate wireless communication between the computing device 400 and a network and/or between the computing device 400 and other computing devices. The network interface 412 can include a built-in network adapter, network interface card, PCMCIA network card, card bus network adapter, wireless network adapter, USB network adapter, modem or any other device suitable for interfacing the computing device 400 to any type of network capable of communication and performing the operations described herein.

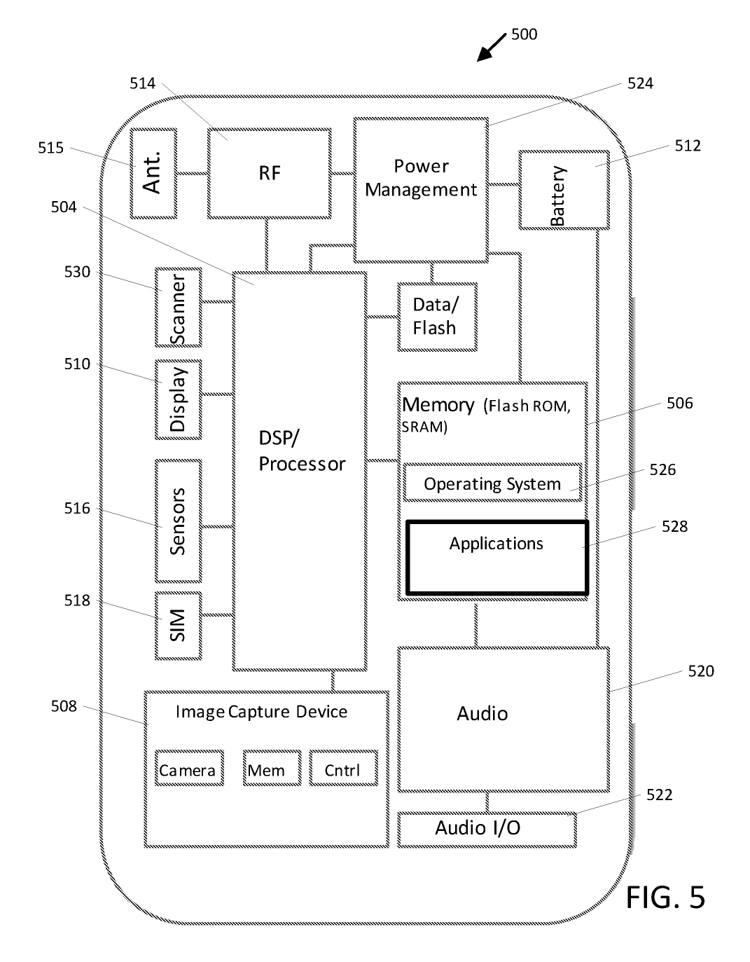

FIG. 5 is a block diagram of an exemplary mobile device that can be utilized to detect accidents in a facility according to an exemplary embodiment. The mobile device 500 can be a smartphone, tablet, subnotebook, laptop, personal digital assistant (PDA), handheld device, such as a Symbol ® MC18and/or any other suitable mobile device that can be programmed and/or configured to implement and/or interact with embodiments of the system via wireless communication. For example, the mobile device 500 can be a Symbol® MC18. Symbol® MC18 can be a handheld mobile computer configured to execute the Android and/or Windows operating system. The Symbol® MC18can include 1D and 2D Scanner, Wi-Fi (802.11a/b/g/n), Camera, VGA Display, Android 2.3 and/or Windows 7, 1 GB RAM/8 GB Flash, Standard Battery.

The mobile device 500 can include a processing device 504, such as a digital signal processor (DSP) or microprocessor, memory/storage 506 in the form a non-transitory computer-readable medium, an image capture device 508, a touch-sensitive display 510, a power source 512, a radio frequency transceiver 514 and a reader 530. Some embodiments of the mobile device 500 can also include other common components commonly, such as sensors 516, subscriber identity module (SIM) card 518, audio input/output components 520 and 522 (including e.g., one or more microphones and one or more speakers), and power management circuitry 524. The sensors 516 can include a location-based sensor 534, configured to determine the location of the mobile device 500.

The memory 506 can include any suitable, non-transitory computer-readable storage medium, e.g., read-only memory (ROM), erasable programmable ROM (EPROM), electrically-erasable programmable ROM (EEPROM), flash memory, and the like. In exemplary embodiments, an operating system 526 and applications 528 can be embodied as computer-readable/executable program code stored on the non-transitory computer-readable memory 506 and implemented using any suitable, high or low level computing language and/or platform, such as, e.g., Java, C, C++, C#, assembly code, machine readable language, and the like. In some embodiments, the applications 528 can include a facility application configured to interact with the microphone, a web browser application, a mobile application specifically coded to interface with one or more servers of embodiments of the system for data transfer in a distributed environment. While memory is depicted as a single component those skilled in the art will recognize that the memory can be formed from multiple components and that separate non-volatile and volatile memory devices can be used.

The processing device 504 can include any suitable single-or multiple-core microprocessor of any suitable architecture that is capable of implementing and/or facilitating an operation of the mobile device 500. For example, a user can use the mobile device 500 in a facility to perform an image capture operation, capture a voice input of the user (e.g., via the microphone), transmit messages including a captured image and/or a voice input and receive messages from another computing system, display data/information including GUIs of the user interface 510, captured images, voice input transcribed as text, and the like. The mobile device 500 can perform the aforementioned operations on an internet browser executing on the mobile device, or any web-based application. The processing device 504 can be programmed and/or configured to execute the operating system 526 and applications 528 to implement one or more processes and/or perform one or more operations. The processing device 504 can retrieve information/data from and store information/data to the storage device 506.

The RF transceiver 514 can be configured to transmit and/or receive wireless transmissions via an antenna 515. For example, the RF transceiver 514 can be configured to transmit data/information, such as input based on user interaction with the mobile device 500. The RF transceiver 514 can be configured to transmit and/or receive data/information having at a specified frequency and/or according to a specified sequence and/or packet arrangement.

The touch-sensitive display 510 can render user interfaces, such as graphical user interfaces to a user and in some embodiments can provide a mechanism that allows the user to interact with the GUIs. For example, a user may interact with the mobile device 500 through touch-sensitive display 510, which may be implemented as a liquid crystal touch-screen (or haptic) display, a light emitting diode touch-screen display, and/or any other suitable display device, which may display one or more user interfaces (e.g., GUIs) that may be provided in accordance with exemplary embodiments.

The power source 512 can be implemented as a battery or capacitive elements configured to store an electric charge and power the mobile device 500. In exemplary embodiments, the power source 512 can be a rechargeable power source, such as a battery or one or more capacitive elements configured to be recharged via a connection to an external power supply. The scanner 530 can be implemented as an optical reader configured to scan and decode machine-readable elements disposed on objects.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components, or steps can be replaced with a single element, component, or step Likewise, a single element, component, or step can be replaced with multiple elements, components, or steps that serve the same purpose. Moreover, while exemplary embodiments have been shown and described with references to particular embodiments thereof, those of ordinary skill in the art will understand that various substitutions and alterations in form and detail can be made therein without departing from the scope of the present disclosure. Further, still, other aspects, functions, and advantages are also within the scope of the present disclosure.

Exemplary flowcharts are provided herein for illustrative purposes and are non-limiting examples of methods. One of ordinary skill in the art will recognize that exemplary methods can include more or fewer steps than those illustrated in the exemplary flowcharts and that the steps in the exemplary flowcharts can be performed in a different order than the order shown in the illustrative flowcharts.

We claim:

1. An accident monitoring system in a facility, the system comprising:
a server;
a reporting device communicatively coupled to the server, the reporting device being configured to:
retrieve a current task item for a user associated with the reporting device;
monitor condition information via the reporting device, the condition information being associated with the current task by the reporting device;
populate a graphical user interface on the reporting device with a list of possible incidents based on the current task and in response the condition information;
transmit selection of one of the possible incidents from the list of possible incidents to the server;
a remediating device communicatively coupled to the server, the remediating device being configured to:
retrieve a list of remedies from the server in response to receipt of the selected one of possible incidents;
populate a graphical user interface on the remediating device with the list of remedies;
transmit a selection of one of the remedies from the list of remedies to the server;
wherein, in response to receipt of the selected one of the remedies, the server automatically transmits a dispatch message to at least a third user device.

2. The system of claim 1, wherein the reporting device receives status information from a plurality of sensors communicatively coupled to the reporting device or included in the reporting device.

3. The system of claim 2, wherein at least a subset of the plurality of sensors are disposed remotely from and in selective communication with the reporting device, wherein the reporting device establishes a communication channel with the subset of the plurality of sensors based on at least one of the current task item or the condition information.

4. The system of claim 2, wherein at least a subset of the plurality of sensors are disposed remotely from and in selective communication with the reporting device, wherein the reporting device terminates a communication channel with the subset of the plurality of sensors based on at least one of the current task item or the condition information.

5. The system of claim 2, wherein the status information comprises an unexpected change in an output of at least one of the plurality of sensors.

6. The system of claim 2, wherein the status information comprises indication of abrupt load shift.

7. The system of claim 2, wherein the plurality of sensors include at least one of an accelerometer, a gyroscope, or a scale.

8. The system of claim 7, wherein the condition information comprises location information and the status information.

9. The system of claim 1, wherein the server selects the third user device as a recipient of the dispatch message based on the selected one of the remedies.

10. The system of claim 1, wherein the reporting device receives input in the form a voice command to facilitate selection of the one of the incidents.

11. A method implemented in an accident monitoring system, the method comprising:
retrieving a current task item for a user associated with the reporting device;
monitoring condition information via the reporting device, the condition information being associated with the current task by the reporting device;
populating a graphical user interface on the reporting device with a list of possible incidents based on the current task and in response the condition information;
transmitting selection of one of the possible incidents from the list of possible incidents to the server;
retrieving, at a second device, a list of remedies from the server in response to receipt of the selected one of possible incidents;
populating a graphical user interface on the remediating device with the list of remedies;
transmitting a selection of one of the remedies from the list of remedies to the server;
wherein, in response to receipt of the selected one of the remedies, the server automatically transmits a dispatch message to at least a third user device.

12. The method of claim 11, wherein the reporting device receives status information from a plurality of sensors communicatively coupled to the reporting device or included in the reporting device.

13. The method of claim 12, wherein at least a subset of the plurality of sensors are disposed remotely from and in selective communication with the reporting device, wherein the reporting device establishes a communication channel with the subset of the plurality of sensors based on at least one of the current task item or the condition information.

14. The method of claim 12, wherein at least a subset of the plurality of sensors are disposed remotely from and in selective communication with the reporting device, wherein the reporting device terminates a communication channel with the subset of the plurality of sensors based on at least one of the current task item or the condition information.

15. The method of claim 12, wherein the status information comprises an unexpected change in an output of at least one of the plurality of sensors.

16. The method of claim 12, wherein the status information comprises indication of abrupt load shift.

17. The method of claim 12, wherein the plurality of sensors include at least one of an accelerometer, a gyroscope, or a scale.

18. The method of claim 17, wherein the condition information comprises location information and the status information.

19. The method of claim 11, wherein the server selects the third user device as a recipient of the dispatch message based on the selected one of the remedies.

20. A non-transitory computer readable medium, having stored thereon, instructions that when executed by a computing device, cause the computing device to perform operations comprising:
retrieving a current task item for a user associated with a reporting device;
monitoring condition information via the reporting device, the condition information being associated with the current task by the reporting device;
populating a graphical user interface on the reporting device with a list of possible incidents based on the current task and in response the condition information; and
transmitting selection of one of the possible incidents from the list of possible incidents to the server;
retrieving, at a second device, a list of remedies from the server in response to receipt of the selected one of possible incidents;
populating a graphical user interface on the remediating device with the list of remedies;
transmitting a selection of one of the remedies from the list of remedies to the server;
wherein, in response to receipt of the selected one of the remedies, the server automatically transmits a dispatch message to at least a third user device.
